(19) United States
(12) Patent Application Publication
(10) Pub. No.: US 2022/0150848 A1
(43) Pub. Date: May 12, 2022

(54) METHOD AND APPARATUS FOR CONTROLLING TRANSMISSION POWER ON A SIDELINK

(71) Applicant: LENOVO (BEIJING) LIMITED, Beijing (CN)

(72) Inventors: Zhennian Sun, Beijing (CN); Xiaodong Yu, Beijing (CN); Haipeng Lei, Beijing (CN)

(21) Appl. No.: 17/435,521

(22) PCT Filed: Mar. 1, 2019
(86) PCT No.: PCT/CN2019/076754

§ 371 Date: Sep. 1, 2021

(51) Int. Cl. H04W 52/38; H04W 52/24; H04W 52/26; H04W 52/36; H04W 52/28

(52) U.S. Cl. CPC H04W 52/383; H04W 52/242; H04W 52/28; H04W 52/367; H04W 52/265

(57) ABSTRACT

The present application is related to a method performed by a user equipment (UE). The method includes: obtaining a power based at least in part on path-loss of a link between the UE and a base unit; obtaining another power based at least in part on path-loss of a sidelink between the UE and another UE; selecting one of the power and the abovementioned another power as transmission power; and transmitting data on the sidelink using the transmission power.

### TECHNICAL FIELD

The present application generally relates to sidelink communication, and more specifically relates to a method and apparatus for controlling transmission power on a sidelink during sidelink communication.

### BACKGROUND

Vehicle to everything (V2X) has been introduced into 5G wireless communication technology. Device-to-device (D2D) communication is applicable to public safety and commercial communication use-cases, and also to V2X scenarios. In terms of a channel structure of D2D communication, the direct link between two user equipments (UEs) is called a sidelink. Sidelink is a long-term evolution (LTE) feature introduced in 3GPP (3rd Generation Partnership Project) Release 12, and enables a direct communication between proximal UEs, and data does not need to go through a base station (BS) or core network.

In order to meet the requirements of providing relatively good performance on D2D communication, sidelink, or NR sidelink (e.g., advanced 3GPP NR (New radio) V2X service), technologies of controlling transmission power on a sidelink are developed.

### SUMMARY

Some embodiments of the present application provide a method performed by a user equipment (UE). The method includes: obtaining a power based at least in part on path-loss of a link between the UE and a base unit; obtaining another power based at least in part on path-loss of a sidelink between the UE and another UE; selecting one of the power and the abovementioned another power as transmission power; and transmitting data on the sidelink using the transmission power.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement a method performed by a UE for transmitting data.

Some embodiments of the present application provide a method performed by a base unit. The method includes: receiving a power adjustment request from a UE; generating a power adjustment command in response to the power adjustment request; and transmitting the power adjustment command to the UE, wherein the power adjustment command is used to adjust transmission power on a sidelink between the UE and another UE.

Some embodiments of the present application also provide an apparatus. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement a method performed by a base unit.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore to be considered as limiting of its scope.

FIG. 1 illustrates an exemplary sidelink communication system in accordance with some embodiments of the present application.

FIG. 2 illustrates another exemplary sidelink communication system in accordance with some embodiments of the present application.

FIG. 3 illustrates another exemplary sidelink communication system in accordance with some embodiments of the present application.

FIG. 4 illustrates another exemplary sidelink communication system in accordance with some embodiments of the present application.

FIG. 5 illustrates another exemplary sidelink communication system in accordance with some embodiments of the present application.

FIG. 6 illustrates a flow chart of a method for transmitting data in accordance with some embodiments of the present application.

FIG. 7 illustrates a flow chart of a method for performing power adjustment in accordance with some embodiments of the present application.

FIG. 8 illustrates a block diagram of an exemplary apparatus in accordance with some embodiments of the present application.

### DETAILED DESCRIPTION

The detailed description of the appended drawings is intended as a description of the currently preferred embodiments of the present application, and is not intended to represent the only form in which the present application may be practiced. It should be understood that the same or equivalent functions may be accomplished by different embodiments that are intended to be encompassed within the spirit and scope of the present application.

UE(s) under NR V2X scenario may be referred to as V2X UE(s). A V2X UE, which transmits data according to sidelink resource(s) scheduled by a base station (BS), may be referred to as a UE for transmitting, a transmitting UE, a transmitting V2X UE, a Tx UE, a V2X Tx UE, or the like. A V2X UE, which receives data according to sidelink resource(s) scheduled by a BS, may be referred to as a UE for receiving, a receiving UE, a receiving V2X UE, an Rx UE, a V2X Rx UE, or the like.

A BS under NR V2X scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

A BS may serve a number of V2X UEs within a serving area, for example, a cell or a cell sector via a wireless communication link. A BS may communicate directly with one or more of V2X UEs via communication signals. For example, a BS may serve V2X UEs within a macro cell.

Sidelink communication under NR V2X scenario includes groupcast communication, unicast communication, or broadcast communication.

NR V2X supports a shared carrier scenario, in which a carrier is shared between different links of network entities within the NR V2X network architecture. For example, if a link between network entities and another link between different network entities use a shared carrier to transmit data or signaling, transmission(s) on the link may cause interference(s) to transmission(s) on the abovementioned another link. Accordingly, a channel quality of the abovementioned another link cannot be guaranteed, due to the interference(s) from the link.

More specifically, under a shared carrier scenario, a Tx UE may transmit data to an Rx UE on a sidelink between the Tx UE and the Rx UE using carrier 1, and the Tx UE may communicate with a BS on a link between the Tx UE and the BS using carrier 1, as well. That is, the transmission(s) between the Tx UE and the Rx UE and the transmission(s) between the Tx UE and the BS share carrier 1. In the case that a data transmission on the sidelink causes interference(s) to a link between another UE(s) and the BS, a link reception quality at the BS may be impacted, wherein the abovementioned another UE(s) represents a UE other than the Tx UE or the Rx UE. Thus, the link reception quality of the BS cannot be guaranteed.

Given the above, in an NR V2X communication system, there is a need to address a power control scheme for sidelink data transmission, to mitigate interference(s) to a BS as well as guarantee a sidelink reception quality of an Rx UE.

Some embodiments of the present application provide a mechanism for controlling sidelink transmission power. Some embodiments of the present application provide a mechanism for transmitting data according to the controlled sidelink transmission power. Some embodiments of the present application provide a mechanism for adjusting sidelink transmission power.

Some embodiments of the present application provide an apparatus for controlling sidelink transmission power. Some embodiments of the present application provide an apparatus for transmitting data according to the controlled sidelink transmission power. Some embodiments of the present application provide an apparatus for adjusting sidelink transmission power.

Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), 3GPP LTE Release 12 and onwards, etc. It is contemplated that along with the 3GPP and related communication technology development, the terminologies recited in the present application may change, which should not affect the principle of the present application.

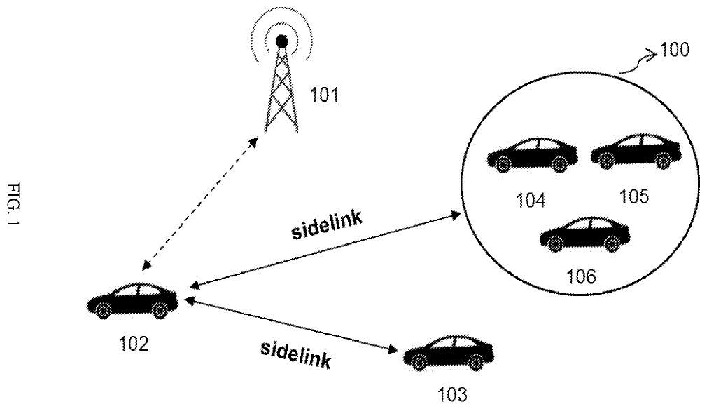

FIG. 1 illustrates an exemplary sidelink communication system in accordance with some embodiments of the present application. As shown in FIG. 1, the sidelink communication system includes a base station, i.e., BS 101, and some UEs, i.e., UE 102, UE 103, UE 104, UE 105, and UE 106. UE 102, UE 103, UE 104, UE 105, and UE 106 may be configured to perform sidelink unicast transmission, sidelink groupcast transmission, or sidelink broadcast transmission.

It is contemplated that, in accordance with some other embodiments of the present application, a sidelink communication system may include more or fewer BSs, more or fewer UEs, more or fewer UE groupcast groups, and more or fewer UE broadcast groups; and moreover, a UE groupcast group or a UE broadcast group may include different numbers of UEs at different time, along with joining and leaving of UE(s) during sidelink communication.

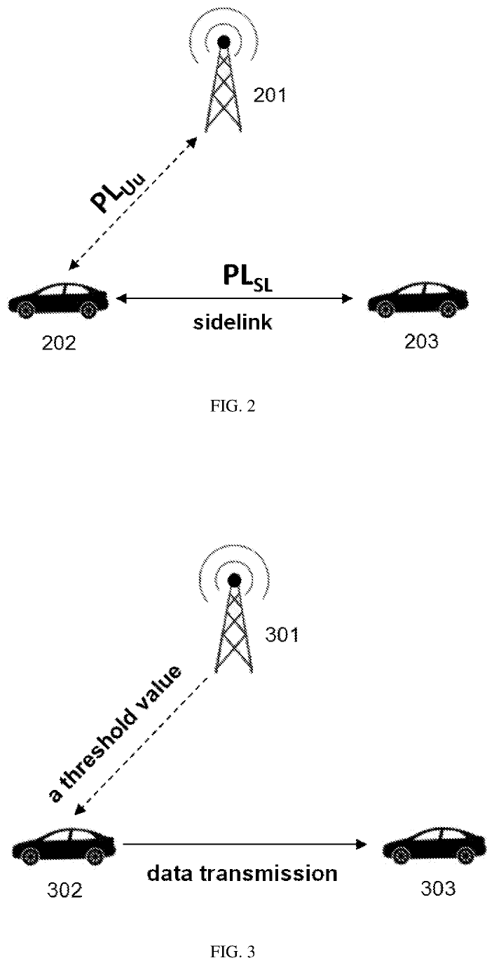

It is contemplated that, in accordance with some other embodiments of the present application, names of UEs (which represent a Tx UE, an Rx UE, and etc.) shown in FIG. 1 may be different, e.g., UE 117, UE 118, and UE 119 or the like. Moreover, although each UE shown in FIG. 1 is illustrated in the shape of a car, it is contemplated that a sidelink communication system may include any type of UE (e.g., a roadmap device, a cell phone, a computer, a laptop, IoT (internet of things) device or other type of device) in accordance with some other embodiments of the present application. Each of FIGS. 2-5 in the present application has the same characteristics as those of FIG. 1.

According to the embodiments of FIG. 1, UE 102 functions as a Tx UE. UE 102 may transmit information to BS 101 and receive control information from BS 101. UE 102 may transmit information or data to other UE(s) within the sidelink communication system, through sidelink unicast, sidelink groupcast, or sidelink broadcast. For instance, UE 102 transmits data to UE 103 in a sidelink unicast session, wherein UE 103 functions as an Rx UE. UE 104, UE 105, and UE 106 form a group of Rx UEs. Such group of Rx UEs may be referred to as a receiving group 100. UE 102 may transmit data to all UEs in the receiving group 100 by either a sidelink groupcast transmission session or a sidelink broadcast transmission session. Also, UE 102 may transmit data to UE 103 and all UEs in the receiving group 100 by a sidelink broadcast transmission session.

Under a shared carrier scenario of the sidelink communication system as shown in FIG. 1, UE 102 transmits data to an Rx UE (e.g., UE 103 or UE 105) on a sidelink using carrier 1, and UE 102 communicates with BS 101 on a link using carrier 1, as well. Due to the interference(s) from the sidelink data transmission, the channel quality of the link between BS 101 and UE 102 cannot be guaranteed. However, using less power for the sidelink data transmission, so as to reduce interference(s) to BS 101, may cause decline of a sidelink reception quality of the Rx UE. Thus, the sidelink communication system needs to implement a power control scheme for sidelink data transmission from a Tx UE to an Rx UE, in order to mitigate interference(s) to a BS and guarantee a sidelink reception quality of the Rx UE.

In some embodiments of the present application, a sidelink communication system addresses a power control scheme based on at least one of pathloss between a link between a BS and a Tx UE and pathloss between a sidelink between the Tx UE and an Rx UE. A Tx UE may determine the final sidelink transmission power according to the power control scheme implemented in the sidelink communication system.

In some embodiments of the present application, a Tx UE may obtain the pathloss between the Tx UE and an Rx UE through channel reciprocity. Specifically, the Rx UE may perform sidelink transmission, e.g., sidelink data or sidelink reference signal(s), and then the Tx UE may estimate the pathloss using the received sidelink data or sidelink reference signal(s) from the Rx UE. Alternatively, the Tx UE may perform sidelink transmission, e.g., sidelink data or sidelink reference signal(s), and then the Rx UE may transmit the received signal strength, e.g., sidelink Reference Signal Receiving Power (RSRP), to the Tx UE; after that, the Tx UE may obtain the pathloss between the Tx UE and the Rx UE.

FIG. 2 illustrates another exemplary sidelink communication system in accordance with some embodiments of the present application. Similar to FIG. 1, the sidelink communication transmission implemented in the embodiments of FIG. 2 includes unicast transmission, groupcast transmission, and broadcast transmission; and the total number of BSs, the total number of UEs, and names of UEs (which represent a Tx UE or an Rx UE) shown in FIG. 2 may vary.

According to the embodiments of FIG. 2, BS 201 represents a base station, UE 202 represents a Tx UE, and UE 203 represents an Rx UE. UE 203 may represent an Rx UE for unicast transmission, an Rx UE for groupcast transmission, or an Rx UE for broadcast transmission. UE 202, which functions as a Tx UE, transmits information to BS 201 and receives control information from BS 201. UE 202 transmits data to UE 203 through a sidelink unicast session, a sidelink groupcast session, or a sidelink broadcast session. Each of FIGS. 3-5 in the present application has the same characteristics as those of FIG. 2.

The embodiments of FIG. 2 introduce a power control scheme based on both pathloss between a link between a BS and a Tx UE and pathloss between a sidelink between the Tx UE and an Rx UE. Specifically, Power 1 and Power 2 are two transmission power values which may be used by a Tx UE (e.g., UE 202 as illustrated and described with reference to FIG. 2) to transmit data to an Rx UE (e.g., UE 203 as illustrated and described with reference to FIG. 2) on a sidelink between the Tx UE and the Rx UE. Power 1 and Power 2 may be referred to as P₁ and P₂, respectively.

P₁ represents the maximum transmission power that can be used by a Tx UE (e.g., UE 202 as illustrated and described with reference to FIG. 2) to transmit data to an Rx UE (e.g., UE 203 as illustrated and described with reference to FIG. 2) on a sidelink between the Tx UE and the Rx UE. For example, P₁ may be obtained based at least in part on pathloss of a link between a BS (e.g., BS 201 as illustrated and described with reference to FIG. 2) and the Tx UE. The pathloss of the link between the BS and the Tx UE may be referred to as PL_{Uu}. If the transmission power of the sidelink transmission is greater than P₁, the reception quality of the BS (e.g., BS 201 as illustrated and described with reference to FIG. 2) would be impacted by the sidelink transmission. Since P₁ is the maximum transmission power of the sidelink transmission, the reception quality of the BS can be guaranteed if the sidelink transmission power does not exceed P₁.

P₂ represents a minimum transmission power that can be used by a Tx UE (e.g., UE 202 as illustrated and described with reference to FIG. 2) to transmit data to an Rx UE (e.g., UE 203 as illustrated and described with reference to FIG. 2) on a sidelink between the Tx UE and the Rx UE, so as to guarantee the sidelink reception quality of the Rx UE. For example, P₂ may be obtained based at least in part on pathloss of the sidelink between the Tx UE and the Rx UE. The pathloss between the sidelink may be referred to as PL_{SL}. If the transmission power of the sidelink transmission is not smaller than P₂, the channel quality of the sidelink between the Tx UE and the Rx UE can be guaranteed.

In some embodiments of the present application, each of P₁ and P₂ may be obtained further based on one or more network parameters configured by the BS (e.g., BS 201 as illustrated and described with reference to FIG. 2). For instance, P₁ is calculated as a function of PL_{Uu} and one or more parameters that are associated with the corresponding PSSCH (Physical Sidelink Share Channel) resource configuration; and P₂ is calculated as a function of PL_{SL} and one or more parameters that are associated with the corresponding PSSCH resource configuration. A Tx UE (e.g., UE 202 as illustrated and described with reference to FIG. 2) may obtain each of P₁ and P₂ based on other network parameter(s) configured by the BS.

After obtaining P₁ and P₂, the Tx UE may determine an actual transmission power for sidelink data transmission according to the obtained P₁ and P₂. More specifically, the Tx UE may select one of P₁ and P₂ as the transmission power, and then transmit data on the sidelink between the Tx UE and an Rx UE (e.g., UE 203 as illustrated and described with reference to FIG. 2) using the transmission power.

In some embodiments of the present application, in the case that P₁ is equal to or greater than P₂, the Tx UE may select P₂ as the transmission power to transmit data on the sidelink between the Tx UE and the Rx UE. Such selection is beneficial for saving transmission power on the sidelink, and is also beneficial for mitigating interference(s) for a link between another UE(s) and the BS.

In some embodiments of the present application, in the case that P₁ is less than P₂, the Tx UE may select P₁ as the transmission power to transmit data on the sidelink between the Tx UE and the Rx UE. A benefit of such selection is that interference(s) for a link between another UE(s) and the BS may be mitigated. Put differently, the reception quality of the BS is well guaranteed. However, since a power that is less than P₂ is adopted to transmit data on the sidelink between the Tx UE and the Rx UE, the sidelink reception quality of the Rx UE will be reduced in some degrees.

In some embodiments of the present application, in the case that P₁ is less than P₂, the Tx UE may alternatively select P₂ as the transmission power to transmit data on the sidelink between the Tx UE and the Rx UE. A benefit of such selection is that the sidelink reception quality of the Rx UE is guaranteed, due to adopting P₂ to transmit data on the sidelink between the Tx UE and the Rx UE. However, since a power (i.e., P₂) that is greater than P₁ is adopted to transmit data on the sidelink between the Tx UE and the Rx UE, significant interference(s) may be caused to a link between another UE(s) and the BS, and the channel quality of the link between the abovementioned another UE(s) and the BS cannot be guaranteed.

FIG. 3 illustrates another exemplary sidelink communication system in accordance with some embodiments of the present application. Similar to FIG. 2, in embodiments as shown in FIG. 3, BS 301 represents a base station, UE 302 represents a Tx UE, and UE 303 represents an Rx UE.

Similar to FIG. 2, the embodiments of FIG. 3 also introduce a power control scheme based on both pathloss between a link between a BS and a Tx UE (e.g., PL_{Uu}) and pathloss between a sidelink between the Tx UE and an Rx UE (e.g., PL_{SL}). In the power control scheme in the embodiments of FIG. 3, a Tx UE (e.g., UE 302 as illustrated and described with reference to FIG. 3) determines the actual transmission power for data transmission on a sidelink (e.g., a sidelink between UE 302 and UE 303 as illustrated and described with reference to FIG. 3) based on a Quality of Service (QoS) requirement of the data transmission and a threshold value.

For example, a QoS requirement(s) of a sidelink service includes at least one of priority level, latency, and reliability of the sidelink service. A threshold value for one of the above requirements may be configured by a BS (e.g., BS 301 as illustrated and described with reference to FIG. 3). A BS may configure a threshold value according to different characteristic(s) of different Tx UE(s) in a sidelink transmission system. For example, a self-driving car may control its speed based on the communications with the base station. Thus, the latency requirement for the self-driving car should be stricter than that for a cell phone. In some embodiments, the threshold value configured by a BS is associated with the QoS requirement of a sidelink service. A BS (e.g., BS 301 as illustrated and described with reference to FIG. 3) may transmit the configured threshold value to a Tx UE (e.g., UE 302 as illustrated and described with reference to FIG. 3). Thus, the Tx UE may compare a specific QoS requirement of a sidelink service with the configured threshold value, and then decide an actual transmission power for data transmission on the sidelink service based on a comparison result of the QoS requirement and the threshold value.

Specifically, in some embodiments of FIG. 3, after obtaining P₁ and P₂, in the case that P₁ is less than P₂, a Tx UE (e.g., UE 302 as illustrated and described with reference to FIG. 3) may compare a QoS parameter for a sidelink between the Tx UE and an Rx UE (e.g., UE 303 as illustrated and described with reference to FIG. 3) and the configured threshold value, and then select the actual transmission power based on a comparison result.

In some embodiments of the present application, if the QoS parameter is equal to or below the threshold value, a Tx UE (e.g., UE 302 as illustrated and described with reference to FIG. 3) may select P₁ as the actual transmission power for data transmission on a sidelink (e.g., a sidelink between UE 302 and UE 303 as illustrated and described with reference to FIG. 3). Alternatively, if the QoS parameter is above the threshold value, the Tx UE may select P₂ as the actual transmission power for the data transmission on the sidelink. For example, ‘0-7’ represents the priority level of QoS, wherein ‘0’ represents the lowest priority and ‘7’ represents the highest priority. The configured threshold value is one value among ‘0-7’, e.g., ‘3’; if the priority of the sidelink transmission is equal to or smaller than ‘3’, the Tx UE may select P₁ as the actual transmission power for sidelink transmission; alternatively, if the priority of the sidelink transmission is greater than ‘3’, the Tx UE may select P₂ as the actual transmission power for the data transmission on the sidelink.

In some embodiments of the present application, if the QoS parameter is equal to or above the threshold value, a Tx UE (e.g., UE 302 as illustrated and described with reference to FIG. 3) may select P₁ as the actual transmission power for data transmission on a sidelink (e.g., a sidelink between UE 302 and UE 303 as illustrated and described with reference to FIG. 3). Alternatively, if the QoS parameter is below the threshold value, the Tx UE may select P₂ as the actual transmission power for the data transmission on the sidelink. For example, ‘0-7’ represents the priority level of QoS, wherein ‘0’ represents the highest priority and ‘7’ represents the lowest priority. The configured threshold value is one value among ‘0-7’, e.g., ‘3’; if the priority of the sidelink transmission is equal to or greater than ‘3’, the Tx UE may select P₁ as the actual transmission power for sidelink transmission; alternatively, if the priority of the sidelink transmission is smaller than ‘3’, the Tx UE may select P₂ as the actual transmission power for the data transmission on the sidelink.

The embodiments of FIG. 3 are much flexible and beneficial, because a tradeoff between “interference(s) to the reception quality of the BS” and “the sidelink reception quality of the Rx UE” is reasonably made based on the QoS requirement(s) of the sidelink service.

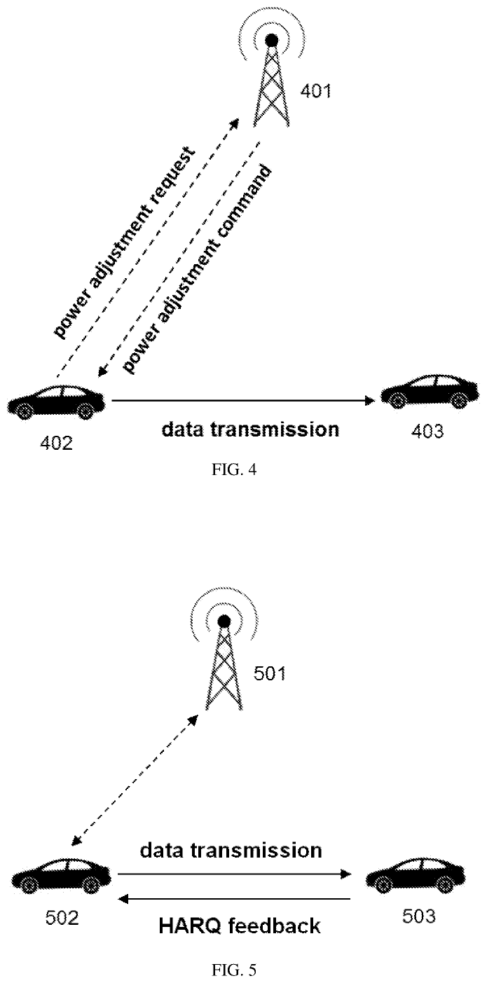

FIG. 4 illustrates another exemplary sidelink communication system in accordance with some embodiments of the present application. Similar to FIGS. 2 and 3, in embodiments as shown in FIG. 4, BS 401 represents a base station, UE 402 represents a Tx UE, and UE 403 represents an Rx UE.

Similar to FIGS. 2 and 3, the embodiments of FIG. 4 also introduce a power control scheme based on both pathloss between a link between a BS and a Tx UE (e.g., PL_{UG}) and pathloss between a sidelink between the Tx UE and an Rx UE (e.g., PL_{SL}). In the power control scheme in the embodiments of FIG. 4, after obtaining P₁ and P₂, a Tx UE (e.g., UE 402 as illustrated and described with reference to FIG. 4) firstly selects a lesser one of P₁ and P₂ as an actual transmission power for data transmission on a sidelink (e.g., a sidelink between UE 402 and UE 403 as illustrated and described with reference to FIG. 4); and secondly, the Tx UE may adjusts the actual transmission power when necessary.

Specifically, in some embodiments of FIG. 4, in the case that P₁ is equal to or greater than P₂, a Tx UE (e.g., UE 402 as illustrated and described with reference to FIG. 4) selects P₂ an actual transmission power to transmit data on a sidelink between the Tx UE and an Rx UE (e.g., UE 403 as illustrated and described with reference to FIG. 4). In the case that P₁ is less than P₂, the Tx UE selects P₁ as an actual transmission power to transmit data on the sidelink between the Tx UE and the Rx UE. Then, the Tx UE detects whether the selected sidelink transmission power can meet the required sidelink reception quality of the Rx UE.

In the case that the selected sidelink transmission power cannot meet the required sidelink reception quality, a Tx UE (e.g., UE 402 as illustrated and described with reference to FIG. 4) may send a power adjustment request to a BS (e.g., BS 401 as illustrated and described with reference to FIG. 4). After receiving the power adjustment request, the BS may transmit a power adjustment command to the Tx UE. The Tx UE may adjust the current sidelink transmission power upon receiving the power adjustment command from the BS. After that, the Tx UE may transmit data on the sidelink using the adjusted transmission power.

A BS (e.g., BS 401 as illustrated and described with reference to FIG. 4) may configure a power adjustment command according to different characteristic(s) of different UE(s) in a sidelink transmission system. A power adjustment command may include a power adjustment amount, to indicate a specific adjusting amount of the current sidelink transmission power. A Tx UE (e.g., UE 402 as illustrated and described with reference to FIG. 4) may adjust the current sidelink transmission power using the specific adjusting amount indicated in the power adjustment command. A power adjustment command may further include a type of the power adjustment command as an increase command, to indicate the Tx UE to increase the current sidelink transmission power by the specific adjusting amount.

For example, a power adjustment command is a transmission power control (TPC) command. A TPC command may comprise a specific power adjustment amount for a sidelink between a Tx UE (e.g., UE 402 as illustrated and described with reference to FIG. 4) and an Rx UE (e.g., UE 403 as illustrated and described with reference to FIG. 4). A power adjustment command may also be referred to as a power control command.

The embodiments of FIG. 4 are much flexible and beneficial, because a tradeoff between “interference(s) to the reception quality of the BS” and “the sidelink reception quality of the Rx UE” is reasonably made based on a detection result of sidelink reception quality using the selected sidelink transmission power.

FIG. 5 illustrates another exemplary sidelink communication system in accordance with some embodiments of the present application. Similar to FIGS. 2-4, in embodiments as shown in FIG. 5, BS 501 represents a base station, UE 502 represents a Tx UE, and UE 503 represents an Rx UE.

As depicted above, according to embodiments of FIG. 4, a Tx UE (e.g., UE 402 as illustrated and described with reference to FIG. 4) firstly selects a lesser one of P₁ and P₂ as an actual transmission power for data transmission on a sidelink (e.g., a sidelink between UE 402 and UE 403 as illustrated and described with reference to FIG. 4), after that, the Tx UE may detect whether the selected sidelink transmission power can meet the required sidelink reception quality of an Rx UE (e.g., UE 403 as illustrated and described with reference to FIG. 4). The embodiments of FIG. 5 make a further explanation to the embodiments of FIG. 4.

Specifically, according to embodiments of FIG. 5, a Tx UE (e.g., UE 502 as illustrated and described with reference to FIG. 5) transmits data on a sidelink to an Rx UE (e.g., UE 503 as illustrated and described with reference to FIG. 5) using the selected sidelink transmission power; and then, the Rx UE sends hybrid automatic repeat request acknowledgement (HARQ-ACK\NACK) feedback regarding the data transmitted on the sidelink. After receiving the HARQ-ACK\NACK feedback sent from the Rx UE, the Tx UE may determine the sidelink reception quality of the Rx UE based on the specific HARQ-ACK\NACK feedback values, and then determine whether the selected sidelink transmission power can meet the required sidelink reception quality of the Rx UE.

For instance, if a Tx UE (e.g., UE 502 as illustrated and described with reference to FIG. 5) finds that there are a plurality of the Negative Acknowledgement (NACK) feedbacks (e.g., beyond a normal range of a QoS requirement) regarding the data transmitted on a sidelink, the Tx UE may determine that the sidelink reception quality of an Rx UE (e.g., UE 503 as illustrated and described with reference to FIG. 5) is poor and the selected sidelink transmission power cannot guarantee the sidelink reception quality of the Rx UE. Thus, the Tx UE may send a power adjustment request to a BS (e.g., BS 501 as illustrated and described with reference to FIG. 5), to request adjusting the current selected sidelink transmission power, in order to enhance the sidelink reception quality of the Rx UE.

Alternatively, if a Tx UE (e.g., UE 502 as illustrated and described with reference to FIG. 5) finds that there are a few NACK feedbacks (e.g., within a normal range of a QoS requirement) regarding the data transmitted on a sidelink, the Tx UE determines that the sidelink reception quality of an Rx UE (e.g., UE 503 as illustrated and described with reference to FIG. 5) is acceptable and the selected sidelink transmission power can meet the required sidelink reception quality of the Rx UE. Thus, there is no need for the Tx UE to adjust the current selected sidelink transmission power, and the Tx UE would not send a power adjustment request to a BS (e.g., BS 501 as illustrated and described with reference to FIG. 5).

In addition, in some embodiments of the present application (e.g., embodiments of FIGS. 4 and 5), in the case that there is a need to adjust the current selected sidelink transmission power of a Tx UE, upon receiving a power adjustment request from the Tx UE, a BS may perform some operation(s) along with or after transmitting a power adjustment command to the Tx UE.

For example, after receiving a power adjustment request from a Tx UE (e.g., UE 402 or UE 502 as illustrated and described with reference to FIGS. 4 and 5, respectively), a BS (e.g., BS 401 or BS 501 as illustrated and described with reference to FIGS. 4 and 5, respectively) is aware of the increasing requirement of the current transmission power on a sidelink between the Tx UE and an Rx UE (e.g., UE 403 or UE 503 as illustrated and described with reference to FIGS. 4 and 5, respectively). Accordingly, the BS may transmit a power adjustment command to the Tx UE, to allow the Tx UE to increase the current sidelink transmission power. Along with or after transmitting the power adjustment command, the BS may increase a transmission power correspondingly.

With the increasing of the transmission power of a sidelink between a Tx UE and an Rx UE, interference(s) to the reception quality of a BS, that is caused by the sidelink, may increase. By performing the operation of increasing a transmission power, the increased interference(s) from the sidelink between the Tx UE and the Rx UE may be overcome.

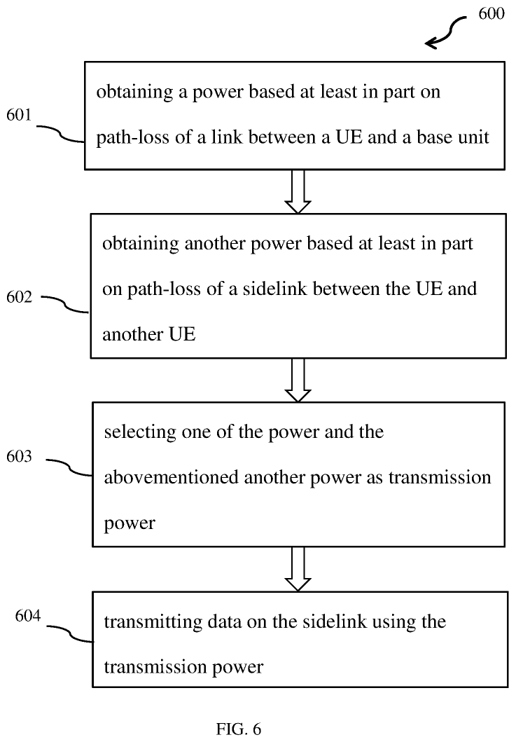

FIG. 6 illustrates a flow chart of a method for transmitting data in accordance with some embodiments of the present application. Referring to FIG. 6, method 600 is performed by a UE (e.g., a Tx UE, UE 102, UE 202, UE 302, UE 402 or UE 502 as illustrated and described with reference to FIGS. 1-5, respectively) in some embodiments of the present application.

In operation 601, a UE (e.g., UE 102, UE 202, UE 302, UE 402 or UE 502 as illustrated and described with reference to FIGS. 1-5, respectively) obtains a power based at least in part on path-loss of a link between the UE and a base unit (e.g., BS 101, BS 201, BS 301, BS 401 or BS 501 as illustrated and described with reference to FIGS. 1-5, respectively). In operation 602, the UE obtains another power based at least in part on path-loss of a sidelink between the UE and another UE (e.g., UE 103, UE 203, UE 303, UE 403 or UE 503 as illustrated and described with reference to FIGS. 1-5, respectively). In operation 603, the UE selects one of the power and the abovementioned another power as transmission power. In operation 604, the UE transmits data on the sidelink using the transmission power.

The details described in all the foregoing embodiments of the present application (for example, how to obtain a power based on path-loss of a link between the UE and a base unit, how to obtain another power based on path-loss of a sidelink between the UE and another UE, and how to select transmission power that is used for transmitting data on a sidelink) are applicable for the embodiments as shown in FIG. 6.

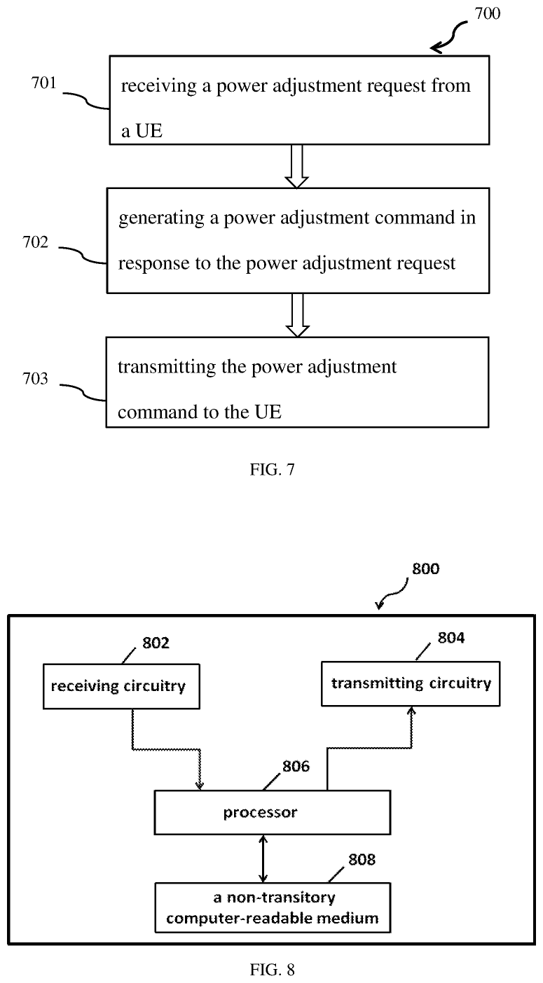

FIG. 7 illustrates a flow chart of a method for performing power adjustment in accordance with some embodiments of the present application. Referring to FIG. 7, method 700 is performed by a BS (e.g., BS 101, BS 201, BS 301, BS 401 or BS 501 as illustrated and described with reference to FIGS. 1-5, respectively) in some embodiments of the present application.

In operation 701, a BS (e.g., BS 101, BS 201, BS 301, BS 401 or BS 501 as illustrated and described with reference to FIGS. 1-5, respectively) receives a power adjustment request from a UE (e.g., UE 102, UE 202, UE 302, UE 402 or UE 502 as illustrated and described with reference to FIGS. 1-5, respectively). In operation 702, the BS generates a power adjustment command in response to the power adjustment request. In operation 703, the BS transmits the power adjustment command to the UE, wherein the power adjustment command is used to adjust transmission power on a sidelink between the UE and another UE (e.g., UE 103, UE 203, UE 303, UE 403 or UE 503 as illustrated and described with reference to FIGS. 1-5, respectively).

The details described in all the foregoing embodiments of the present application (for example, a BS performs some operation(s) along with or after transmitting a power adjustment command to a Tx UE) are applicable for the embodiments as shown in FIG. 7.

FIG. 8 illustrates a block diagram of an exemplary apparatus in accordance with some embodiments of the present application. Referring to FIG. 8, the apparatus 800 includes a non-transitory computer-readable medium 808, a receiving circuitry 802, a transmitting circuitry 804, and a processor 806. The processor 806 is coupled to the non-transitory computer-readable medium 808, the receiving circuitry 802, and the transmitting circuitry 804. The apparatus 800 may include a vehicle, a UE, a V2X UE or other device that is included in a vehicle platoon.

It is contemplated that some components are omitted in FIG. 8 for simplicity. In some embodiments, the receiving circuitry 802 and the transmitting circuitry 804 may be integrated into a single component (e.g., a transceiver).

In some embodiments, the non-transitory computer-readable medium 808 may have stored thereon computer-executable instructions to cause a processor to implement the operations with respect to the UE(s) as described above. For example, the computer-executable instructions may be executed to cause the processor 806 to control the receiving circuitry 802 and transmitting circuitry 804 to perform the operations with respect to the vehicle(s) as described and illustrated with respect to FIGS. 2-7.

The method of the present application can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which there resides a finite state machine capable of implementing the flowcharts shown in the figures may be used to implement the processor functions of the present application.

Those having ordinary skills in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method performed by a first user equipment, the method comprising:
obtaining a first power based at least in part on path-loss of a link between the first user equipment and a base unit;
obtaining a second power based at least in part on path-loss of a sidelink between the first user equipment and a second user equipment;
selecting one of the first power and the second power as transmission power; and
transmitting data on the sidelink using the transmission power.

2. The method of claim 1, wherein the first power, the second power, or a combination thereof is obtained further based on one or more network parameters configured by the base unit.

3. The method of claim 1, wherein selecting the transmission power comprises:
if the first power is equal to or greater than the second power, selecting the second power as the transmission power.

4. The method of claim 1, wherein selecting the transmission power comprises:
if the first power is less than the second power, comparing a quality of service parameter of the sidelink and a threshold value; and
selecting the transmission power based on a comparison result of the quality of service parameter and the threshold value.

5. The method of claim 4, wherein selecting the transmission power based on the comparison result comprises:
if the quality of service parameter is equal to or below the threshold value, selecting the first power as the transmission power; and
if the quality of service parameter is above the threshold value, selecting the second power as the transmission power.

6. The method of claim 4, wherein selecting the transmission power based on the comparison result comprises:
if the quality of service parameter is equal to or above the threshold value, selecting the first power as the transmission power; and
if the quality of service parameter is below the threshold value, selecting the second power as the transmission power.

7. The method of claim 4, wherein the quality of service parameter includes a priority level, a latency, a reliability, or some combination thereof.

8. The method of claim 4, wherein the threshold value is configured by the base unit.

9. The method of claim 1, wherein selecting the transmission power comprises:
selecting a lesser one of the first power and the second power as the transmission power.

10. The method of claim 9, further comprising:
transmitting a power adjustment request to the base unit;
adjusting the transmission power upon receipt of a power adjustment command from the base unit; and
transmitting data on the sidelink using the adjusted transmission power.

11. The method of claim 10, wherein the power adjustment command is a transmission power control command.

12. The method of claim 10, wherein the power adjustment command comprises a power adjustment amount.

13. A method performed by a base unit, the method comprising:
receiving a power adjustment request from a first user equipment;
generating a power adjustment command in response to the power adjustment request; and
transmitting the power adjustment command to the first user equipment, wherein the power adjustment command is used to adjust transmission power on a sidelink between the first user equipment and a second user equipment.

14. The method of claim 13, wherein the power adjustment command is a transmission power control command.

15. The method of claim 13, wherein the power adjustment command comprises a power adjustment amount.

16. The method of claim 13, further comprising:
adjusting transmission power on a link between the first user equipment and the base unit.

17. The method of claim 13, further comprising:
configuring a threshold value related to a quality of service parameter of the sidelink; and
transmitting the threshold value to the first user equipment.

18. The method of claim 17, wherein the quality of service parameter includes a priority level, a latency, a reliability, or some combination thereof.

19. (canceled)

20. (canceled)

21. An apparatus comprising a first user equipment, the apparatus further comprising:
a processor that:
obtains a first power based at least in part on path-loss of a link between the first user equipment and a base unit;
obtains a second power based at least in part on path-loss of a sidelink between the first user equipment and a second user equipment; and
selects one of the first power and the second power as transmission power; and
a transceiver that transmits data on the sidelink using the transmission power

22. The apparatus of claim 21, wherein the first power, the second power, or a combination thereof is obtained further based on one or more network parameters configured by the base unit.
